(19) United States
(12) Patent Application Publication
(10) Pub. No.: US 2022/0180228 A1
(43) Pub. Date: Jun. 9, 2022

(54) SYSTEM AND METHOD FOR DETERMINATION OF SMART MEASURES FOR USE WITH A DATA ANALYTICS ENVIRONMENT

(71) Applicant: Oracle International Corporation, Redwood Shores, CA (US)

(72) Inventor: Jacques Vigeant, Fort Lauderdale, FL (US)

(21) Appl. No.: 17/543,406

(22) Filed: Dec. 6, 2021

Related U.S. Application Data
(60) Provisional application No. 63/122,592, filed on Dec. 8, 2020.

(51) Int. Cl. G06N 5/04; G06N 5/02; G06F 16/25; G06F 16/28

(52) U.S. Cl. CPC G06N 5/04; G06F 16/283; G06F 16/258; G06N 5/022

(57) ABSTRACT

In accordance with an embodiment, described herein is a system and method for providing dynamically-generated analytic data metrics or measures, referred to herein as smart measures, for use with a data analytics environment. A smart measure can be scoped to a dataset, and associated with a metadata that indicates an understanding of the scoped data or changes thereto of interest to particular users. A system can operate in accordance with a smart measure and associated rules to monitor its associated data, and broadcast relevant information to subscribers, such as, for example, anomalies, trends, or other notable changes. Smart measures can be automatically discovered, defined, or updated by the system, for example as dynamically-generated key performance indicators, based on an understanding of the dataset and/or information received from a community of users. Conditional formatting can be used in presenting the smart measure as, for example, a data metric or visualization.

### CLAIM OF PRIORITY AND CROSS-REFERENCE TO RELATED APPLICATIONS

This application claims the benefit of priority to U.S. Provisional Patent application titled “SYSTEM AND METHOD FOR DETERMINATION OF SMART MEASURES FOR USE WITH AN ANALYTIC APPLICATIONS ENVIRONMENT”, Application No. 63/122,592, filed Dec. 8, 2020; and is related to U.S. patent application titled “AUTOMATIC REDISPLAY OF A USER INTERFACE INCLUDING A VISUALIZATION”, application Ser. No. 15/273,567, filed on Sep. 22, 2016, and issued as U.S. Pat. No. 10,516,980 on Dec. 24, 2019; U.S. patent application titled “TECHNIQUES FOR SEMANTIC SEARCHING”, application Ser. No. 16/662,695, filed on Oct. 24, 2019, and published as U.S. Patent Application Publication No. 2020/0117658 on Apr. 16, 2020; and U.S. patent application titled “TECHNIQUES FOR DATA-DRIVEN CORRELATION OF METRICS”, application Ser. No. 16/586,347, filed on Sep. 27, 2019, and published as U.S. Patent Application Publication No. 2020/0104775 on Apr. 2, 2020; each of which above applications and their contents are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to systems and methods for providing data analytics, and are particularly related to a system and method for providing dynamically-generated analytic data metrics or measures, for use with data analytics environments.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

Systems for data analytics may be provided within the context of a cloud or other shared computing environment. Since different organizational customers or users may have different requirements with regard to what and how their analytic data is presented, the providing of suitable analytic data may require a manual configuration of corresponding dashboards, visualizations, user interfaces, key performance indicators, or other analytic measures that are particularly tailored for those customers/users.

However, the manual configuration and maintenance of large amounts of organization-specific or user-specific key performance indicators and other analytic measures necessitates an administrative burden.

Additionally, the usability of such manually-configured key performance indicators or measures is generally limited to their original purpose, unless once more manually reconfigured to address the organization/user's subsequent needs.

### SUMMARY

In accordance with an embodiment, described herein is a system and method for providing dynamically-generated analytic data metrics or measures, referred to herein as smart measures, for use with a data analytics environment.

In accordance with an embodiment, a smart measure can be scoped to a dataset, and associated with a metadata that indicates an understanding of the scoped data or changes thereto of interest to particular users. A system can operate in accordance with a smart measure and associated rules to monitor its associated data, and broadcast relevant information to subscribers, such as, for example, anomalies, trends, or other notable changes.

In accordance with an embodiment, smart measures can be automatically discovered, defined, or updated by the system, for example as dynamically-generated key performance indicators, based on an understanding of the dataset and/or information received from a community of users. Conditional formatting can be used in presenting the smart measure as, for example, a data metric or visualization.

### BRIEF DESCRIPTION OF THE DRAWINCIS

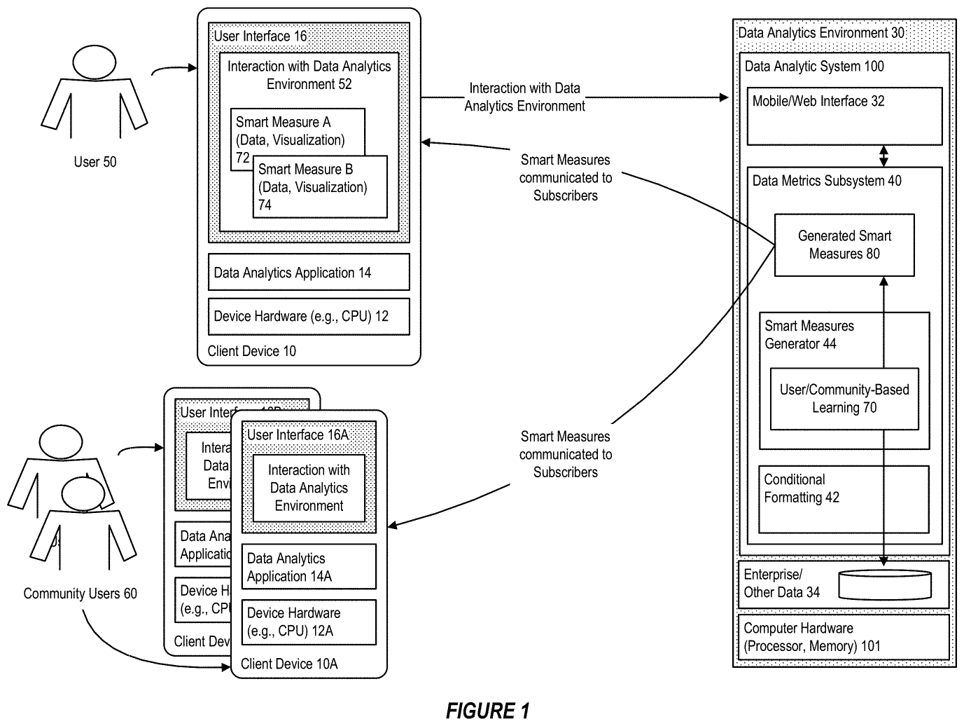

FIG. 1 illustrates a system for providing dynamically-generated analytic data metrics or measures, for use with a data analytics environment, in accordance with an embodiment.

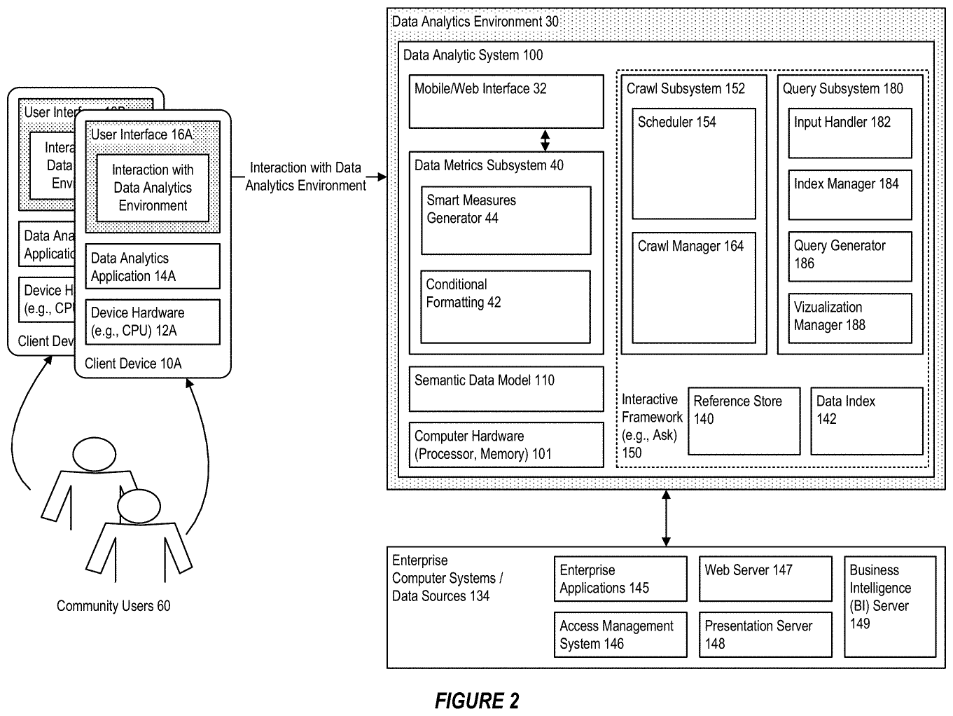

FIG. 2 further illustrates a system for providing dynamically-generated analytic data metrics or measures, in accordance with an embodiment.

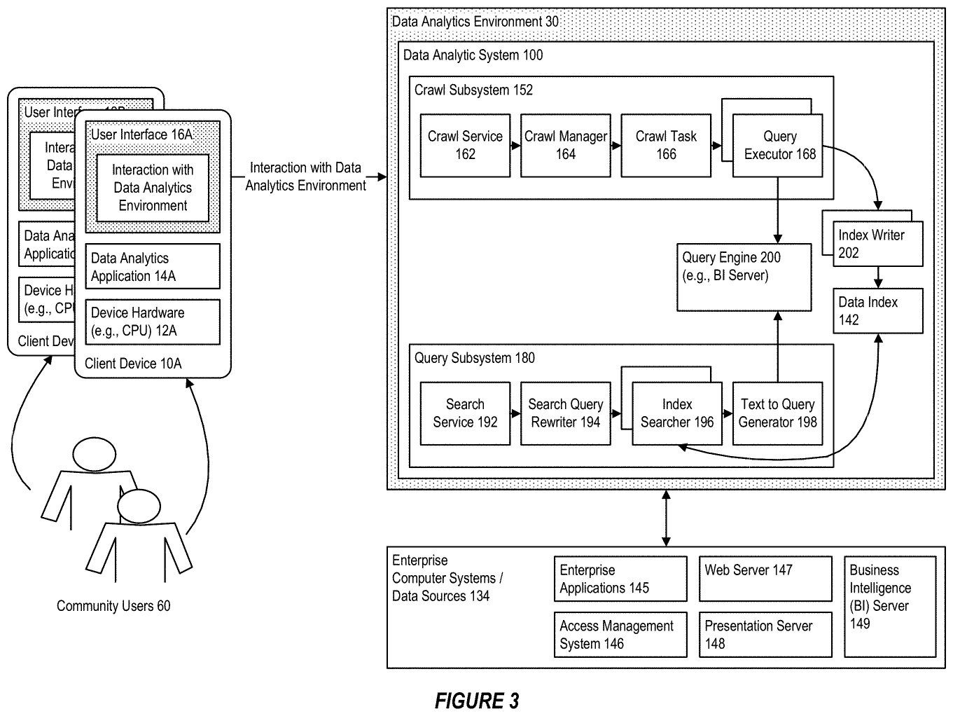

FIG. 3 further illustrates a system for providing dynamically-generated analytic data metrics or measures, in accordance with an embodiment.

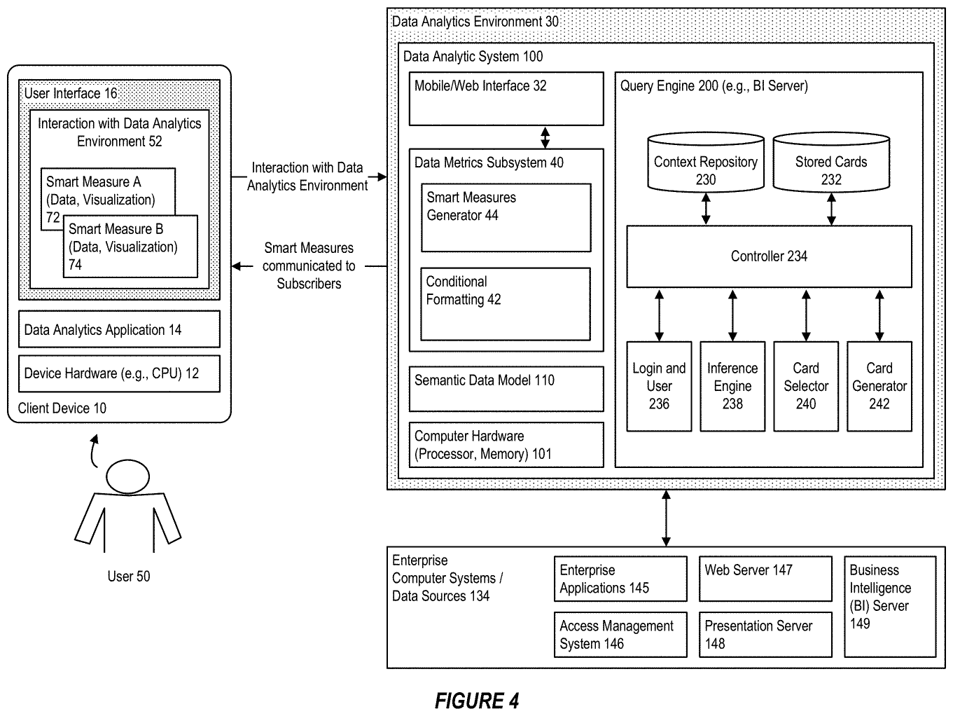

FIG. 4 further illustrates a system for providing dynamically-generated analytic data metrics or measures, in accordance with an embodiment.

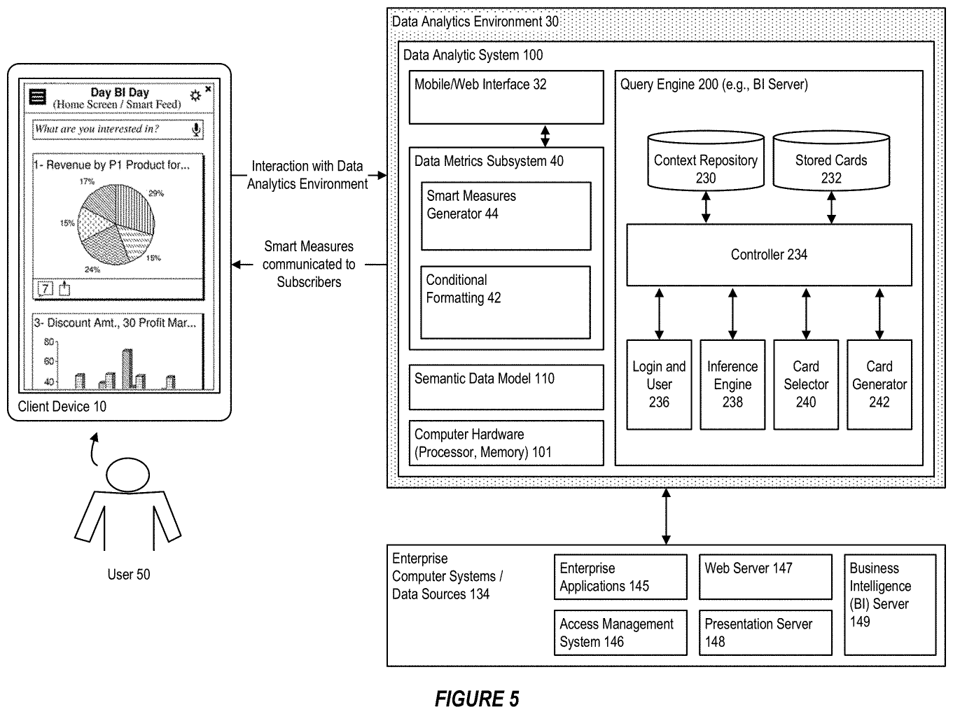

FIG. 5 further illustrates a system for providing dynamically-generated analytic data metrics or measures, in accordance with an embodiment.

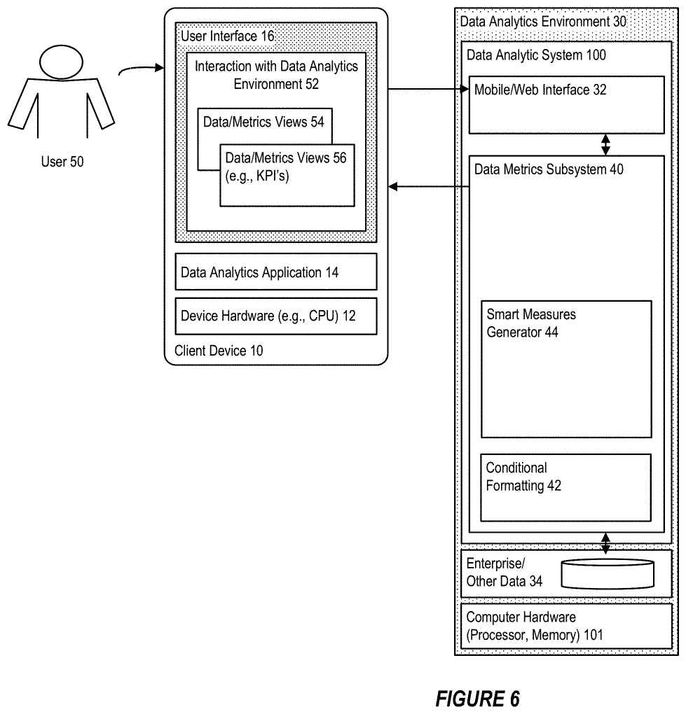

FIG. 6 further illustrates a system for providing dynamically-generated analytic data metrics or measures, in accordance with an embodiment.

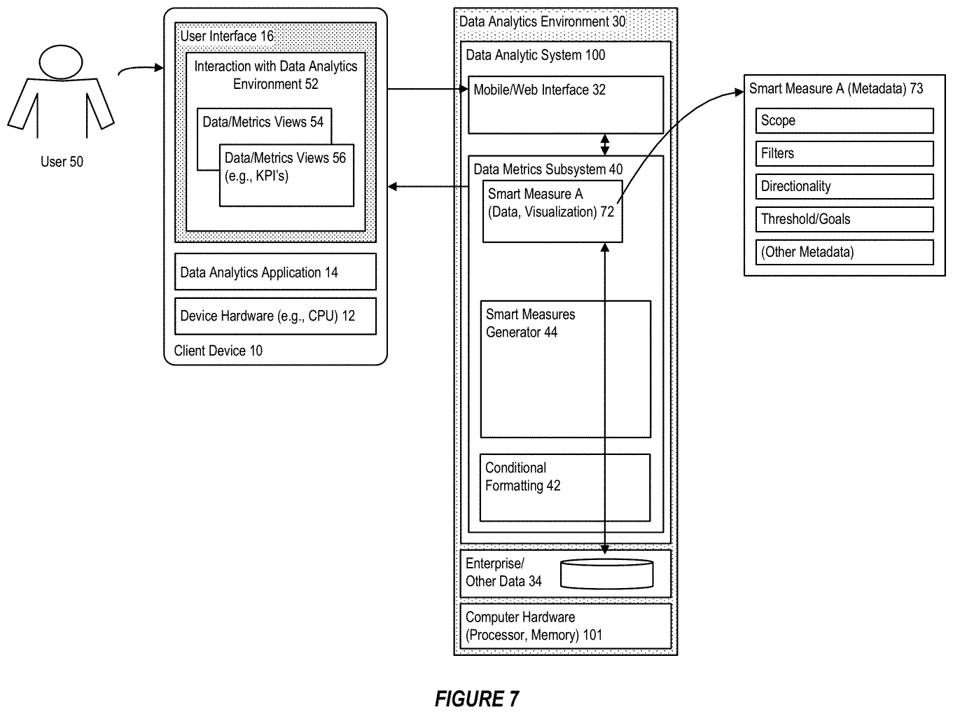

FIG. 7 further illustrates a system for providing dynamically-generated analytic data metrics or measures, in accordance with an embodiment.

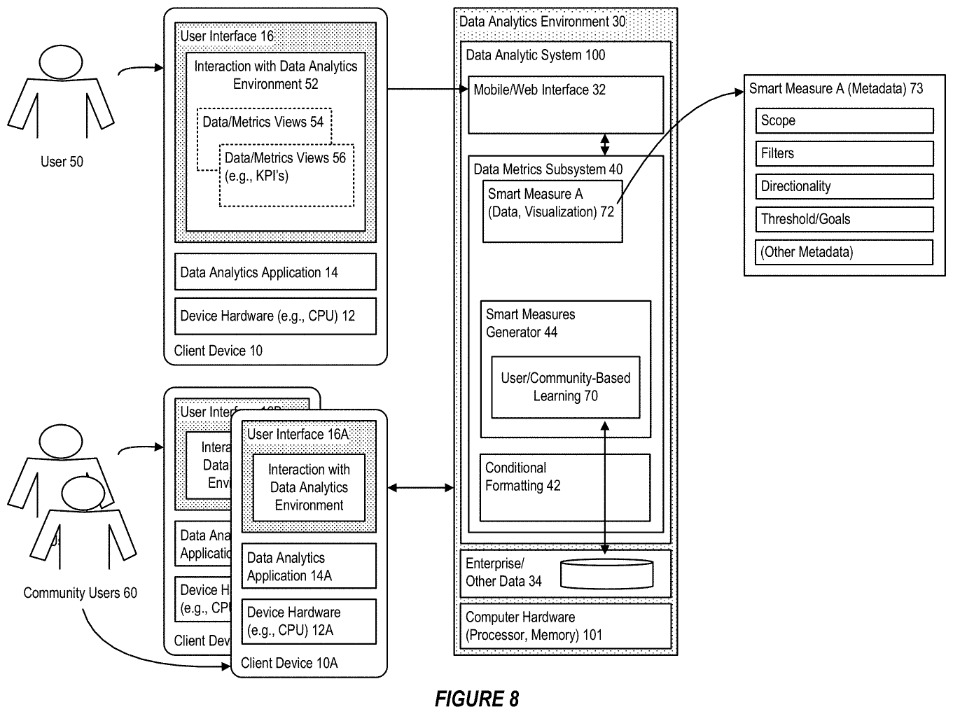

FIG. 8 further illustrates a system for providing dynamically-generated analytic data metrics or measures, in accordance with an embodiment.

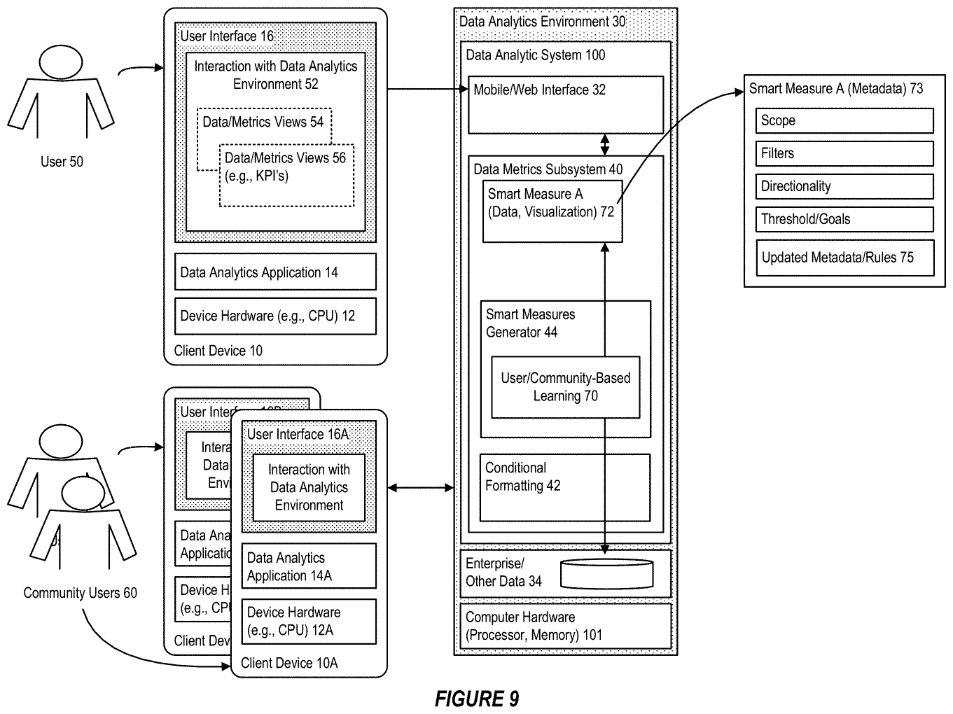

FIG. 9 further illustrates a system for providing dynamically-generated analytic data metrics or measures, in accordance with an embodiment.

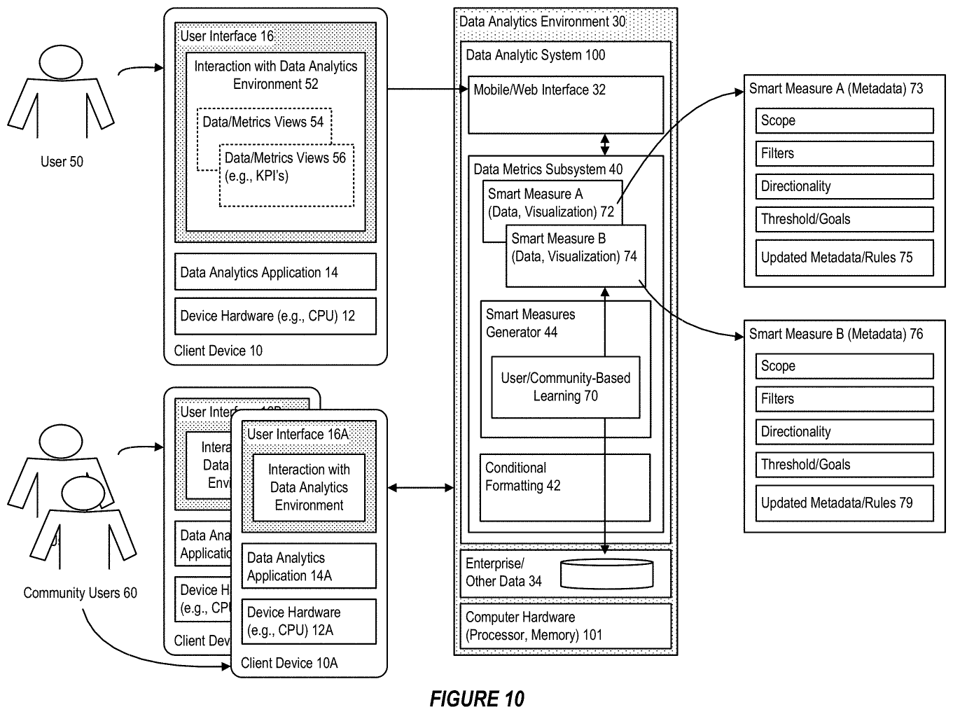

FIG. 10 further illustrates a system for providing dynamically-generated analytic data metrics or measures, in accordance with an embodiment.

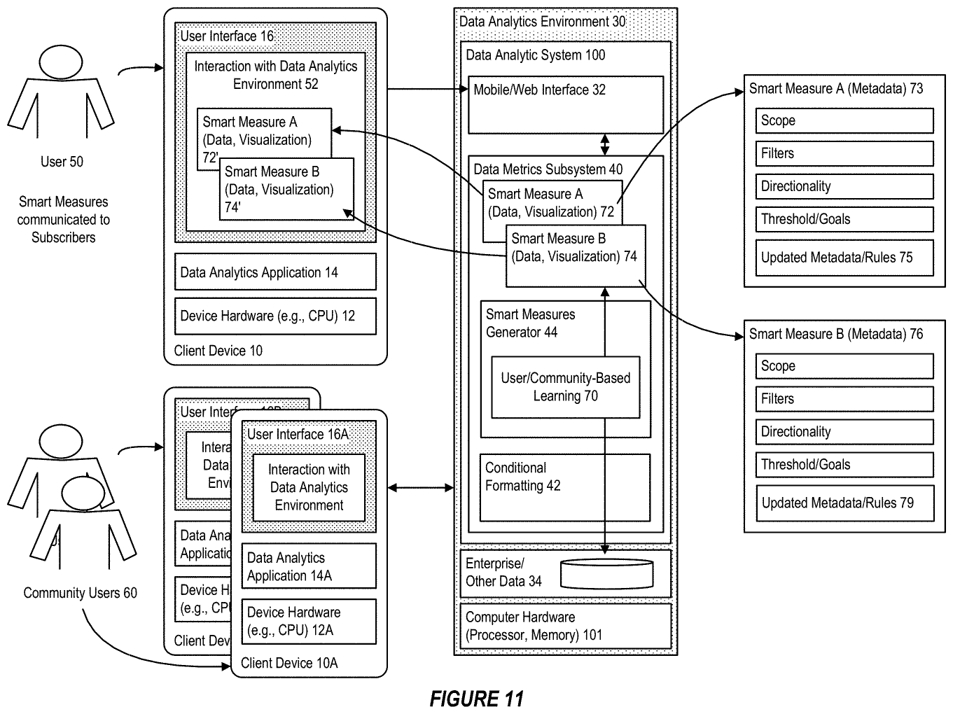

FIG. 11 further illustrates a system for providing dynamically-generated analytic data metrics or measures, in accordance with an embodiment.

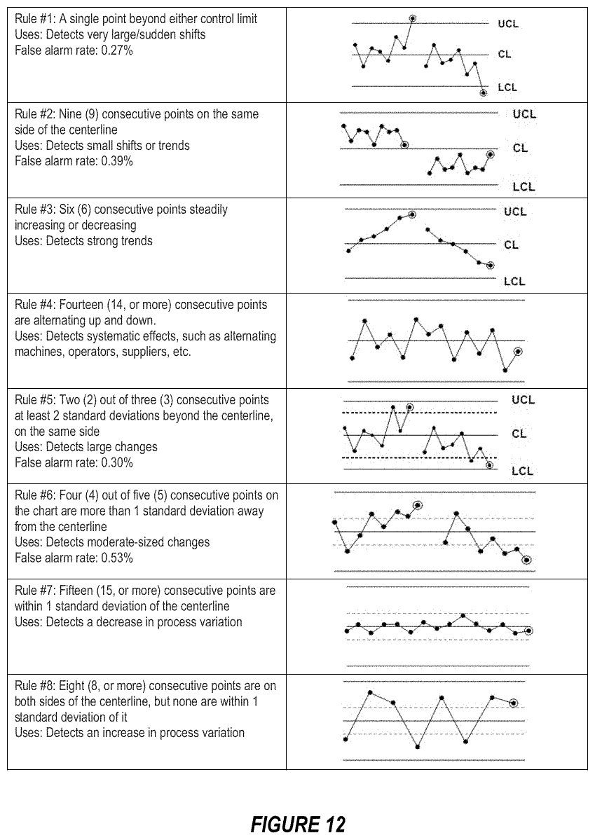

FIG. 12 illustrates various examples of rules that can be used with a system in generating and using dynamically-generated analytic data metrics or smart measures, in accordance with an embodiment.

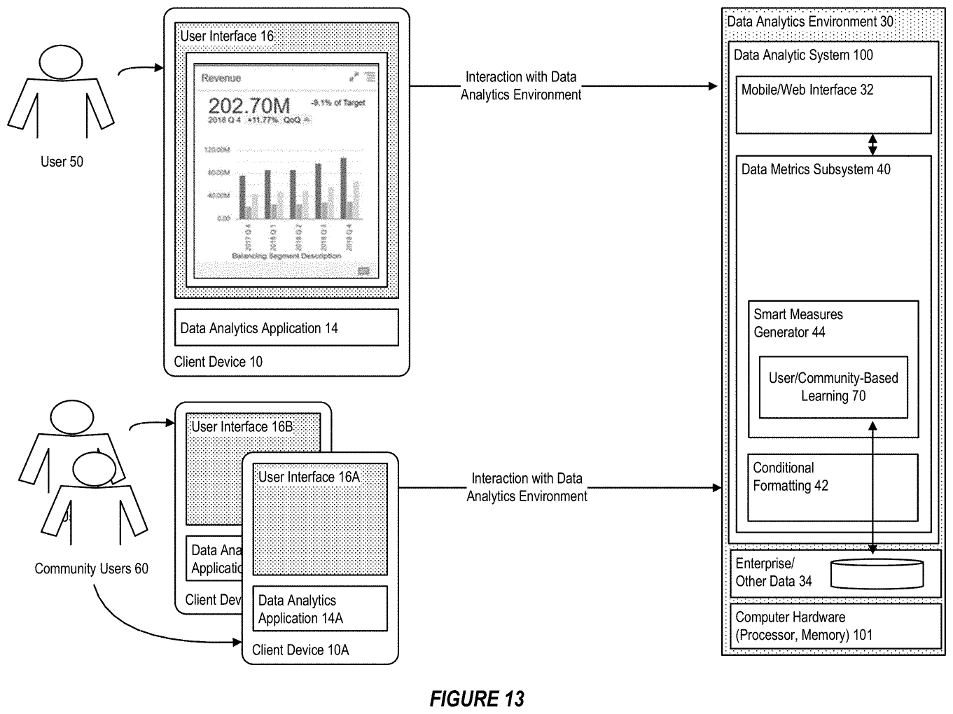

FIG. 13 illustrates an example use of smart measures, in accordance with an embodiment.

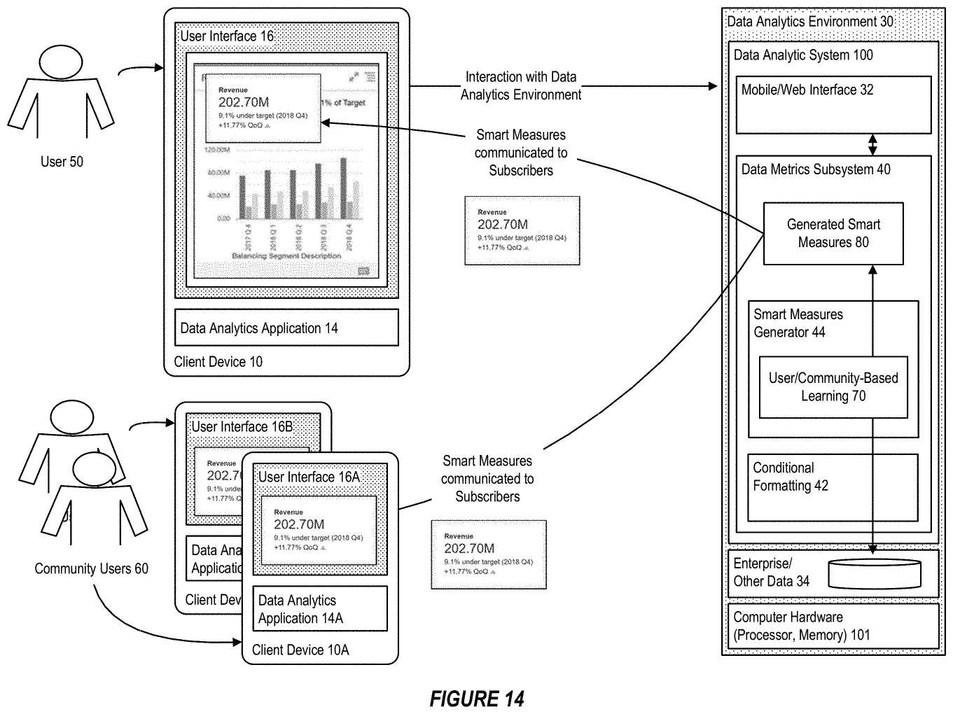

FIG. 14 further illustrates an example use of smart measures, in accordance with an embodiment.

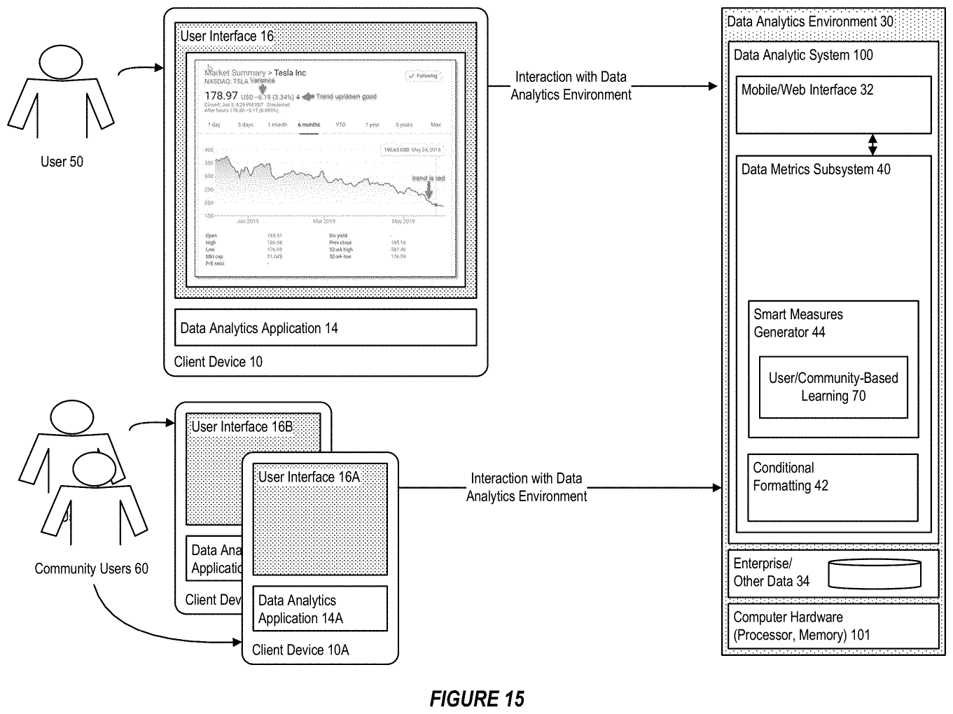

FIG. 15 illustrates another example use of smart measures, in accordance with an embodiment.

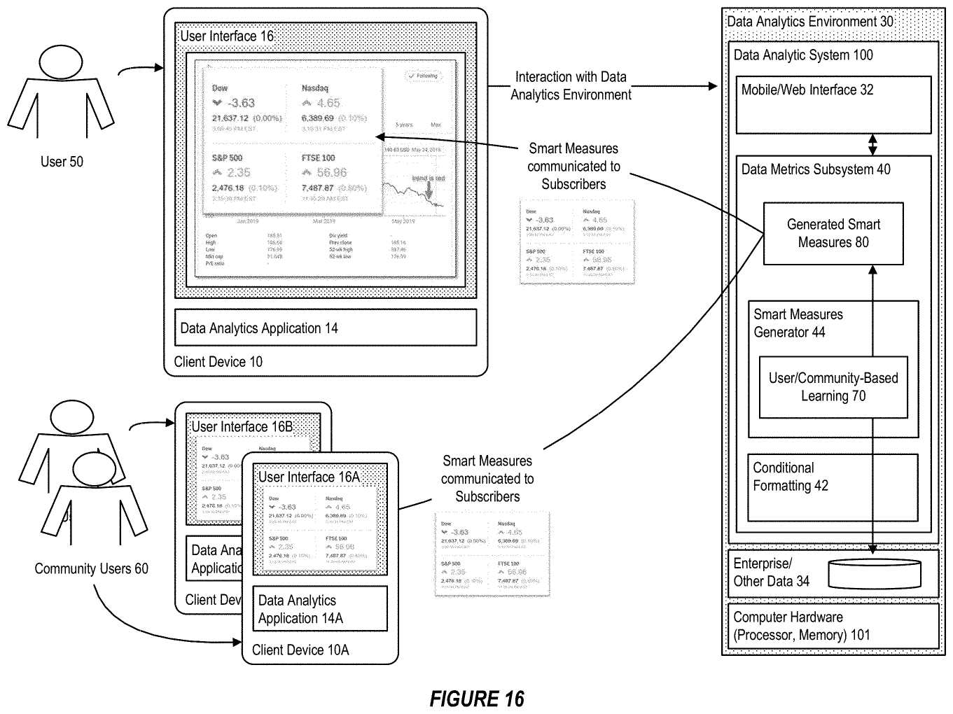

FIG. 16 further illustrates another example use of smart measures, in accordance with an embodiment.

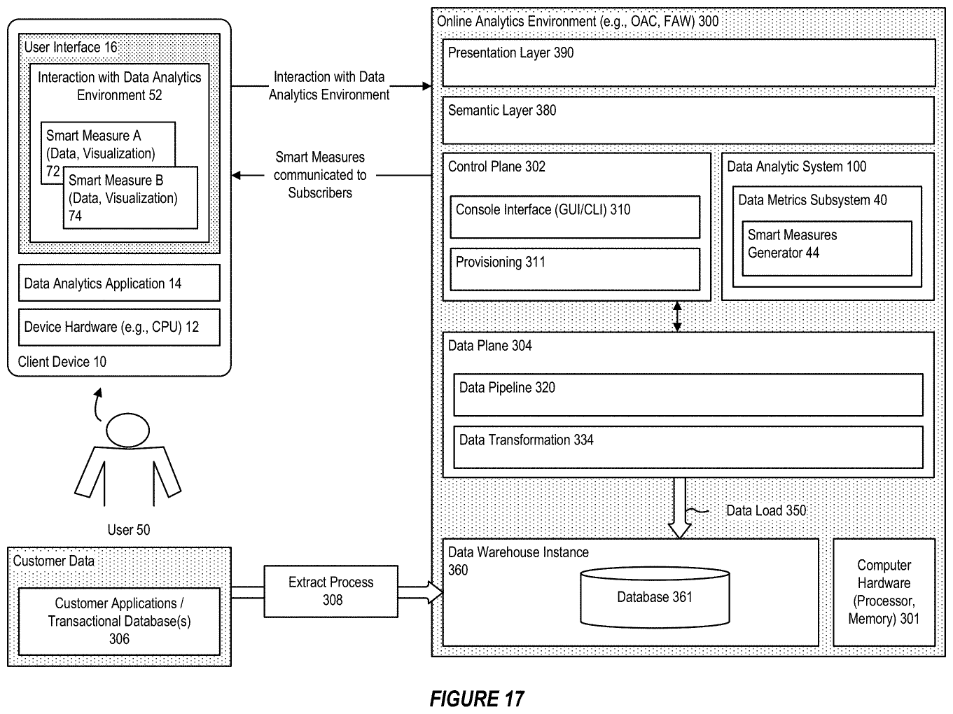

FIG. 17 illustrates an example use of smart measures with a data analytics environment, in accordance with an embodiment.

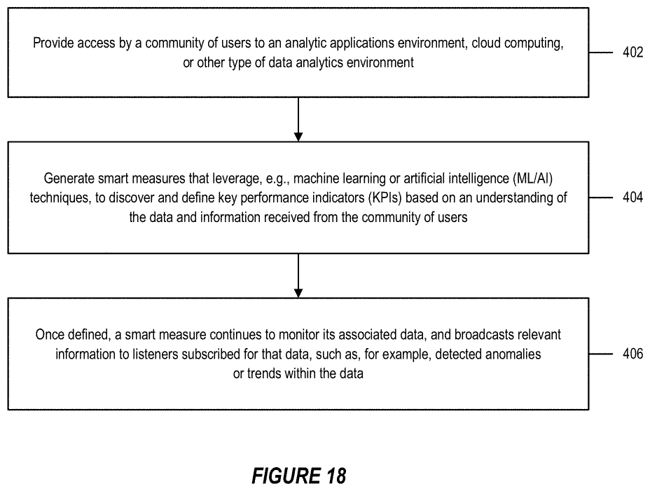

FIG. 18 illustrates a process or method for providing dynamically-generated analytic data metrics or measures, for use with a data analytics environment, in accordance with an embodiment.

### DETAILED DESCRIPTION

As described above, systems for data analytics may be provided within the context of a cloud or other shared computing environment. However, the manual configuration and maintenance of large amounts of organization-specific or user-specific key performance indicators and other analytic measures necessitates an administrative burden. Additionally, the usability of such manually-configured key performance indicators or measures is generally limited to their original purpose, unless once more manually reconfigured to address the organization/user's subsequent needs.

In accordance with an embodiment, described herein is a system and method for providing dynamically-generated analytic data metrics or measures, referred to herein as smart measures, for use with a data analytics environment.

In accordance with an embodiment, a smart measure can be scoped to a dataset, and associated with a metadata that indicates an understanding of the scoped data or changes thereto of interest to particular users. A system can operate in accordance with a smart measure and associated rules to monitor its associated data, and broadcast relevant information to subscribers, such as, for example, anomalies, trends, or other notable changes.

In accordance with an embodiment, smart measures can be automatically discovered, defined, or updated by the system, for example as dynamically-generated key performance indicators, based on an understanding of the dataset and/or information received from a community of users. Conditional formatting can be used in presenting the smart measure as, for example, a data metric or visualization.

In accordance with various embodiments, technical advantages of the systems and methods described herein include that the system can automatically generate analytic data metrics or measures that are associated with or are descriptive of a dataset, which provides for efficient generation of data analytics, and reduces the amount and storage of manually-configured key performance indicators that may otherwise be required to address varying organization-specific or user-specific needs.

Additionally, in accordance with various embodiments, the providing of such dynamically-generated analytic data metrics or measures as smart measures enables the system to effectively configure itself, for example to detect and respond quickly to changes within the associated dataset, including the use of community-sourced information, without delays incurred by human administration.

Dynamically-Generated Analytic Data Metrics (Smart Measures)

In accordance with an embodiment, a dynamically-generated analytic data metric, referred to herein in various embodiments as a “smart measure”, can be viewed as an analytic data metric or measure that is adapted to operate in a dynamically-updated and communicative manner, in the manner of a “self-aware” or “living measure”.

For example, in contrast to a traditional key performance indicator (KPI), which may be manually tailored and updated to address the requirements of a particular organization or user with regard to which and how their analytic data is presented, in accordance with an embodiment, a smart measure can be automatically discovered, defined, or updated by a data analytic system, for example as a dynamically-generated KPI, based on an understanding of the dataset and/or information received from a community of users.

FIG. 1 illustrates a system for providing dynamically-generated analytic data metrics or measures, for use with a data analytics environment, in accordance with an embodiment.

As illustrated in FIG. 1, and as further described below, in accordance with an embodiment, a data analytics environment 30 can include or operate in combination with a data analytic system 100, including a computer hardware 101, that provides access to an enterprise or other data 34, and includes a data metrics subsystem 40 or component that includes a smart measures generator 44 and enables the use of conditional formatting 42.

In accordance with an embodiment, the data analytic system can be provided by a cloud computing system, or other suitably-programmed computer system comprising one or more computer servers, processing units (processors, CPUs), memory, and data storage. The computer operation can be implemented as appropriate in hardware, computer-executable instructions, firmware, or combinations thereof. The data storage can be implemented using a persistent storage device, such as, for example one or memory storage devices or other non-transitory computer-readable storage medium.

In accordance with an embodiment, a client device 10 having a device hardware 12 (e.g., processor/CPU, memory, storage), data analytics application 14, and user interface 16, can communicate with the data analytic system, for example via a mobile/web interface 32 provided by the data analytics environment. A user 50 can use the client device, to interact 52 with the data analytics environment, and view or otherwise access analytic data, such as a set of data metrics or measures operating as KPIs, or other types of metrics.

In accordance with an embodiment, the additional components and processes illustrated in FIG. 1, and as further described herein with regard to various other embodiments, can be provided as software or program code executable by a computer system or other type of processing device.

As further described below, in accordance with an embodiment, the data metrics subsystem enables a smart measure to be scoped to a dataset, and associated with a metadata that indicates an understanding of the scoped data or changes thereto of interest to particular users. The data analytic system can operate in accordance with a smart measure and associated rules to monitor its associated data, and broadcast relevant information to subscribers, such as, for example, anomalies, trends, or other notable changes.

In accordance with an embodiment, the data analytics environment can include or operate in combination with a data crawl/search functionality that can receive, from a community of users, information associated with searching, accessing, and/or using particular types of data or analytic metrics or measures, which information the system can then employ in determining a user's interest in a particular dataset, generating smart measures, or associating particular smart measures with actions that are likely to be of interest to particular users.

In accordance with an embodiment, the data analytics environment can include or operate in combination with a pattern/trend-determination functionality that enables the system to provide relevant information to the user in the form of, e.g., trending or anomalous metrics that are personalized for that particular user.

In accordance with an embodiment, a user may elect to define a smart measure themselves; alternatively the data analytic system can employ statistical, machine learning (ML), artificial intelligence (AI), or other computer-automated processes to learn from the community of users which aspects may be meaningful about a particular analytic metric or measure, and then update an associated metadata progressively over time, for use in generating an appropriate smart measure. The system can continue to use community-provided information to provide incrementally-more-relevant information, as it continues to learn more about each measure.

In accordance with an embodiment, such metadata can include, for example, an indication of scope, filter, directionality, threshold/goals, or other changes within the data likely to be of interest to one or more users. Smart measures can be automatically discovered, defined, or updated by the system, for example as dynamically-generated key performance indicators, based on an understanding of the dataset and/or information received from a community of users, for example with regard to an analytic data metric.

In accordance with an embodiment, users can provide metadata directly, for association with a smart measure; alternatively metadata can be gathered indirectly through various, e.g., data crawl/search environments, such as, for example, an Oracle BI Ask environment.

For example, as illustrated in FIG. 1, in accordance with an embodiment, if the data analytic system observes that the user, or a community of users 60, regularly looks at a particular type of data, or particular analytic data metric, or generally performs actions in response to changes in such data, then the system can apply a user/community-based learning 70 to understand the user's (or the community's) interest in the data, or make inferences from their actions.

In accordance with an embodiment, the data analytic system can record an indication of such updated knowledge/understanding as an updated metadata/rules associated with the smart measure. When a user, or community of users, provides a sufficient amount of metadata for the system to recognize a particular analytic data metric as a smart measure, then one or more dynamically-generated analytic data metrics or measures 72, 74 can be generated 80 by the data analytic system.

In accordance with an embodiment, once a smart measure has been defined and associated with a user, or group of users, the smart measure can be used, communicated, broadcast, or otherwise provided to the user, or to other users as contextually appropriate, for example across different/various types of computing environments, such as, for example, mobile devices, web browsers, on-premise system, or third-party applications.

For example, in accordance with an embodiment, the data analytic system can determine a smart measure for a dataset by collecting metadata that indicates when an analytic metric or measure is, for example, trending (upwardly or downwardly) and meets a threshold that causes the system to associate the trending information with a smart measure.

In accordance with an embodiment, by noting which users may have used similar analytic metrics or measures, the system can associate the smart measure with an indication as to particular users who may be interested in the smart measure, and record such information in an associated metadata.

In accordance with an embodiment, once generated by the data analytic system, the smart measure can exhibit various characteristics, for example in providing an understanding within its associated dataset as to which data points may be good versus bad (e.g., directionality); normal, abnormal or ideal; important thresholds, goals, and benchmarks; or as to which particular users may be interested in receiving such smart measure information.

In accordance with an embodiment, conditional formatting can be used in presenting the smart measure as, for example, a displayed data metric or visualization; and enables a data analytics environment to present information in various different ways within a data visualization, for example to add emphasis to a portion of the visualization to reflect relevant differences in the values of the data.

For example, in accordance with an embodiment, a smart measure can be adapted to utilize conditional formatting in reporting a status about itself (e.g., as red/yellow/green); or use various conditional formatting or other visualization processes to effectively communicate information about how data associated with that smart measure is changing over time; notify people who may be interested in the data; suggest actions appropriate to the data; predict when the smart measure is likely to meet a particular goal; provide trending; provides variances and distances to goals; or provide smart summaries of the data.

In accordance with an embodiment, a smart measure can be adapted to look at past and/or present information, to determine which data appears most meaningful for particular users/subscribers, and then use that knowledge to determine which data provided by an analytic applications environment, cloud computing, or other type of data analytics environment, to monitor and/or report to those users/subscribers.

In accordance with an embodiment, the data analytic system can include or operate in combination with a social/shared information search and retrieval environments, which can be used to receive information from a community of users, associated with accessing and using data, which the system can then employ in understanding the user's interests, and generating appropriate smart measures, or associating particular smart measures with actions that are likely to be of interest to the user.

In accordance with an embodiment, the data analytic system can use input from the community of users to train the system, for example, with appropriate measures and appropriate actions. As users interact with the system, metadata is gathered and associated with appropriate smart measures. The system, as trained, can then generate or define new smart measures based on an analysis of newly-received data. Metadata can be added to particular smart measures or data points, for example to indicate their associated data as being of interest within a particular enterprise or community, or to a particular user.

For example, in accordance with an embodiment, when used with environments such as, for example, Oracle Day-by-Day, the system can augment an existing metadata used in such environments for a particular user, with a smart measure for the user, to indicate the user is interested in that information; and then also leverage that information to provide smart measures for other users in a community.

In accordance with an embodiment, the system can interpret input from a user, for example as text input, associated with a particular dataset or changes therein, and use natural language processing techniques in determining an appropriate smart measure.

For example, in accordance with an embodiment, the data analytic system can leverage metadata obtained by a data crawl/search environment, and supplement the metadata used therein with smart measure metadata. The data crawl/search environment can obtain information as to what data users are interested in; and the user can then follow a smart measure as, for example, an Oracle Day-by-Day feed, or in a social environment or social platform. In this way the standard metadata that may be associated with a user's analytics insight is enriched with additional personal information that identify or suggest the users' interest in a particular measure.

In accordance with an embodiment, the data analytic system can be adapted to poll a community of users, either directly or implicitly, to assess which particular information may be more important, or more likely to be related to other information, or to particular user types; and to then enrich the metadata associated with a measure using information provided by users, and without administrative configuration.

For example, in accordance with an embodiment, the data analytic system can be adapted to poll the community to provide some insights into that data; and can use that community-provided insight to further supplement or tune the metadata associated with the smart measures; in a crowd-sourced or wisdom-of-the crowd manner.

In this way, in accordance with an embodiment, a smart measure can be both personal to the user; and then over time as other users crowdsource the knowledge of the smart measures, the smart measure can become “smarter” for that user, based on that community/peer knowledge; while at the same time offering its benefits to other users in the community, in the manner of suggesting information that may be of interest to them and their particular context.

For example, in accordance with an embodiment, if the system determines that many people are interested in a particular measure or direction since the data analytic system can leverage the crowdsourced information together with a personalized user context to direct the information appropriately, for example to assess what the user is currently, doing and then determine relevant information based on what they may be doing at a particular time.

Data Crawl/Search Functionality

As described above, in accordance with an embodiment, the data analytics environment can include or operate in combination with a data crawl/search functionality that can receive, from a community of users, information associated with searching, accessing, and/or using particular types of data or analytic metrics or measures, which information the system can then employ in determining a user's interest in a particular dataset, generating smart measures, or associating particular smart measures with actions that are likely to be of interest to particular users.

FIG. 2 further illustrates a system for providing dynamically-generated analytic data metrics or measures, in accordance with an embodiment.

In accordance with an embodiment, the environment illustrated in FIG. 2 is provided for purposes of illustrating an example of a data crawl/search functionality that can be used to support smart measures; in accordance with various embodiments, other types of data crawl/search functionality can be used.

As illustrated in FIG. 2, in accordance with an embodiment, the data analytic system can communicate with one or more enterprise computer systems or data sources 134 including, for example, one or more enterprise applications 145, access management system 146, web server 147, presentation server 148, and/or business intelligence (BI) server 149; for purposes of accessing enterprise/other data.

In accordance with an embodiment, the processing of user requests for access to data, or queries, may be limited to those datasets which are accessible to a user, for example based on a role or identity of the user. Alternatively, the data may be crawled at a level associated with all users, for example with respect to a particular enterprise computer system.

In accordance with an embodiment, a crawl subsystem 152 performs operations to generate a reference store 140 and data index 142, that together provide a logical/indexed mapping of the data and can be used in processing a received data request/query. The crawl subsystem can include a scheduler 154 and crawl manager 164, as described in further detail below.

In accordance with an embodiment, a query subsystem 180 can operate in combination with a logical mapping of the data stored in a semantic data model 110, which enables the data index to use for semantic analysis of a received data access request/query. The query subsystem can include an input handler 182, index manager 184, query generator 186, and visualization manager 188, as described in further detail below.

In accordance with an embodiment, the data crawl/search functionality illustrated in FIG. 2 can be provided as part of an interactive framework 150 of or in combination with, for example, an Oracle BI Ask environment.

FIG. 3 further illustrates a system for providing dynamically-generated analytic data metrics or measures, in accordance with an embodiment.

As illustrated in FIG. 3, in accordance with an embodiment, the crawl service 162 operates, for example according to a schedule, to invoke the crawl manager to manage one or more crawls that query data from one or more data sources, and generate an index of the data. The data index can form part of a logical data mapping of the semantic data model.

In accordance with an embodiment, the crawl manager can initiate one or more crawl tasks 166 that when executed perform queries of data from the data sources, based on the language or a query defined for the crawl.

In accordance with an embodiment, a query executor 168 converts a query for a crawl task into a language appropriate to the data source, to generate the index. For example, a query for a crawl task may be converted into a query defined by a logical structured query language (logical SQL).

In accordance with various embodiments, queries may be sent directly to a data source for processing, or alternatively may be issued to a presentation server that requests a BI server 200 to execute the query. An index writer 202 indexes the queries and the data responsive to the queries in the data index.

In accordance with an embodiment, a search service 192 may initiate a crawl based on a user input, which enables a user to search data as an unstructured query in the form most users are familiar. The query subsystem can process an input string by a user to determine a semantic meaning of the input string, including processing the input string into words and comparing those words to the data index to determine a closest match for the terms and/or a semantic meaning.

In accordance with an embodiment, upon receiving a data access request/query, search query rewriter 194 may perform processing to adjust and/or modify the query for searching the index; for example, an input defining a query may be processed to produce a set of terms to search the index. An index searcher 196 may perform a search on index based on the one or more terms output by search query rewriter.

In accordance with an embodiment, based on the closest terms identified by index searcher, the system can determine data corresponding to the matching terms in the index, and provide an output data to query generator 198, which operates to query and/or retrieve the requested data within the data source.

In accordance with an embodiment, the query subsystem may perform operations to selectively determine one or more options for displaying retrieved data responsive to the constructed query; such as, for example, a visualization type for best representing the requested data.

In accordance with an embodiment, optionally, the query subsystem can provide the generated query to a presentation server which provides one or more visual representation types, and which can perform operations to request the BI server to identify and retrieve data responsive to the query, and provide the retrieved data to the presentation server, which generates a graphical interface, for example a dashboard or KPI that provides a visual representation of the retrieved data.

FIGS. 4 and 5 further illustrate a system for providing dynamically-generated analytic data metrics or measures, in accordance with an embodiment.

As illustrated in FIGS. 4 and 5, in accordance with an embodiment, the data analytic system can include a controller 234 that facilitates communication with a user login and permission component 236, an inference engine 238, an automatic card selector 240, a card generator component 242, a context repository 230, and stored cards 232.

In accordance with an embodiment, the data analytic system can leverage intrinsic context information and extrinsic context confirmation to further refine the dynamic generation of analytic data metrics or smart measures. Context information may be metadata associated with, for example, a user, a client computing device or software associated therewith, or a user interaction with the computing device or software.

In accordance with an embodiment, intrinsic context information may be any context information that is specifically chosen or specified by the user; such as, for example, user data access requests or queries, including natural language query statements and expressions.

In accordance with an embodiment, extrinsic context information may be any context information that is not explicitly chosen or specified by a user; such as, for example, user data access permissions or login credentials, client computing device location (e.g., as indicated via a Global Positioning System (GPS) receiver), or user teams or collaboration groups. Extrinsic context information may also include aggregated metrics calculated from an analysis of activities of a community of users.

In accordance with an embodiment, the login and user permissions component facilitates user login to the BI server, for example by receiving a user login information to facilitate confirming user identity and application of appropriate restrictions, e.g., data access permissions, to the user client device. The user identity and associated data access permissions represents a type of context information usable by the system to selectively adjust content provided via the stored cards.

In accordance with an embodiment, the inference engine facilitates query term or expression interpretation, including the use of intrinsic and/or extrinsic context information maintained at the context repository.

In accordance with an embodiment, the automatic card selector component facilitates a mapping of natural language input expressions, for example into Multi-Dimensional eXpressions (MDX); and selection of card types in accordance with the mappings of the input expressions into database dimensions, measures, analytic calculations that are supported by the data source.

In accordance with an embodiment, the card generator facilitates an organizing of data for use in visualizations, including selections of visualizations in accordance with card type determined by the auto card selector, and collecting rendering data used to render the card.

In accordance with an embodiment, the context information maintained by the context repository may include dynamic context information, for example context information subject to periodic or daily change, including context information subject to approximately real time change, for example a GPS location information characterizing the client device, which other persons the user may be communicating with, of which interactions with the data or with measures the user is performing.

In accordance with an embodiment, using such context information the system can facilitate a dynamic or context-based push of appropriate smart measures to the user's device (e.g., a home screen), such that the home screen is updated periodically or in real time.

The above example is provided for purposes of illustration of a particular embodiment. In accordance with various embodiments, the system can utilize additional data crawl/search functionality features, such as those described for example in U.S. patent application titled “TECHNIQUES FOR SEMANTIC SEARCHING”, application Ser. No. 16/662,695, filed on Oct. 24, 2019, and published as U.S. Patent Application Publication No. 2020/0117658 on Apr. 16, 2020.

Smart Measure Generation

FIG. 6 further illustrates a system for providing dynamically-generated analytic data metrics or measures, in accordance with an embodiment.

As illustrated in FIG. 6, in accordance with an embodiment, a client device having a device hardware (e.g., CPU), data analytics application, and user interface, can communicate with a data analytics environment, via a mobile/web interface, wherein the data analytics environment provides access to enterprise/other data, and includes a data metrics subsystem or equivalent component that enables the use of conditional formatting, and a smart measures generator.

In accordance with an embodiment, a user can use the client device, to interact with the data analytics environment, and view or otherwise access various data/metrics 54, 56, such as for example KPIs or other types of metrics.

In accordance with an embodiment, the data metrics subsystem enables a smart measure to be associated with a metadata that indicates a scope of data of interest to a user or group of users. The system operates in accordance with a defined smart measure to monitor its associated data, and broadcast metrics, analytics, or other relevant information to listeners subscribed to the smart measure, such as, for example, detected anomalies, trends, or other notable changes within the data.

FIG. 7 further illustrates a system for providing dynamically-generated analytic data metrics or measures, in accordance with an embodiment.

As illustrated in FIG. 7, in accordance with an embodiment, such metadata 73 can include, for example, an indication of scope, filter, directionality, threshold/goals, or other changes within the data likely to be of interest to one or more users.

FIG. 8 further illustrates a system for providing dynamically-generated analytic data metrics or measures, in accordance with an embodiment.

As illustrated in FIG. 8, in accordance with an embodiment, if the system observes that the user, or a community of users, regularly looks at a particular type of data, or generally performs actions in response to such data, then the system can begin to understand the user's (or the community's) interest in the data, or make inferences from their actions, for example via user/community-based learning and one or more statistical, machine learning, artificial intelligence, or other computer-automated processes.

FIG. 9 further illustrates a system for providing dynamically-generated analytic data metrics or measures, in accordance with an embodiment.

As illustrated in FIG. 9, in accordance with an embodiment, the system can automatically discover, define, or update a smart measure based on an understanding of the data and/or information received from a community of users, and record an indication of such updated knowledge/understanding as an updated metadata/rules 75 associated with the smart measure.

FIG. 10 further illustrates a system for providing dynamically-generated analytic data metrics or measures, in accordance with an embodiment.

As illustrated in FIG. 10, in accordance with an embodiment, one or more smart measures 72, 74 can be generated or updated by the system once a community of users provides a sufficient amount of metadata for the system to recognize the smart measure, including metadata 76 or updated metadata/rules 79 associated with the smart measure.

FIG. 11 further illustrates a system for providing dynamically-generated analytic data metrics or measures, in accordance with an embodiment.

As illustrated in FIG. 11, in accordance with an embodiment, once a smart measure has been defined and associated with a user, or group of users, the smart measure can be used, communicated, broadcast, or otherwise provided to the user, or to other users, as contextually appropriate, for example as one or more visualizations, or across different/various types of computing environments, such as, for example, mobile devices, web browsers, on-premise system, or third-party applications.

Pattern/Trend-Determination Functionality

As described above, in accordance with an embodiment, the data analytics environment can include or operate in combination with a pattern/trend-determination functionality that enables the system to provide relevant information to the user in the form of, e.g., trending or anomalous metrics that are personalized for that particular user.

In accordance with an embodiment, as one or more users access the system and its associated data sources, for example to perform data access requests/queries, the system may identify and track patterns of use for each user, such as initial or subsequent viewing habits, or habitual/frequent actions that can be identified as occurring based on particular or changing data values.

In accordance with an embodiment, the system can then use the patterns identified for the user, together with current data values or trends, to identify information that may be useful to the user based on their usage patterns, and provide that information as smart measures.

In accordance with an embodiment, relevant data/information can be provided to a user if the system determines it is statistically significant, or if the system determines it is relevant within a particular domain. The usage patterns or behavior of a community of users, and/or the behavior of metric indicators over time may be used to identify relationships between the metric indicators.

For example, in accordance with an embodiment, metric indicators may have associated metadata that the system can use to identify a relationship between two or more metric indicators, or analyze the values (trends) of a set of metric indicators to identify leading and lagging indicators.

Optionally, in accordance with an embodiment, the system may identify the relationship between metric indicators by analyzing user logs to find indicators that are viewed closely in time by that user. User logs for multiple users may be used to generate relationships between metric indicators. Relationships created via explicit user definition of the relationship, user logs, and/or metric indicator behavior, may be subsequently used by the system to generate smart measures based on the user's role, the user's behaviors, and/or the user's current view.

In accordance with an embodiment, the system can include processes for crowdsourcing metric indicators. For example, trending metric indicators can include those metric indicators being viewed by other users in a particular organization or team. Trending metric indicators may be identified based on what other users in other organizations are viewing within their organizations as common domain knowledge.

In accordance with an embodiment, an application/user interface, for example as associated with a client device having a data analytics application and user interface, as described above, can be updated by the system's identification of metric indicators which can be configured to be surfaced as smart measures as the user desires.

In accordance with an embodiment, an example of user configuration of such a metric indicator can include setting personalized thresholds that override metric indicator defaults. Threshold types can include, for example, personal thresholds, or benchmarks. The user can configure the manner in which notifications of different severity are sent, for example, to mobile device, email, or voice.

In accordance with an embodiment, the highest informational value content for use with a smart measure may be information about metric indicators that have some statistically significant change associated with them or some statistically significant anomaly associated with them over a time period of interest.

For example, in accordance with an embodiment, an analytic data metric or measure with a trend or trend value at a specific time period, which is not in line with the distribution of expectations based on predictions made by a multi-variate time series model, may be identified as an anomaly. It may be valuable to provide this information to a user as a mart measure, whether the user explicitly asks for that metric indicator or not.

In accordance with an embodiment, data from enterprise data sources is used to identify signal anomalies. The data metrics subsystem can identify metric indicators that may indicate an anomaly signal due to, for example, the metric indicator trending out of threshold.

By way of example, in accordance with an embodiment, for a given metric indicator, the data metrics subsystem may generate a multi-variate dynamic dependency model using, for example, a vector autoregressive integrated moving average process, or other statistical, machine learning, artificial intelligence, or other computer-automated technique. Using such a process, a prediction of a first set of values of a first variable or attribute of the metric indicator is generated based on a dynamic dependency model. The values from the model may be compared with the actual values to determine if the distribution of values observed is significantly divergent from a forecasted prediction.

In accordance with an embodiment, if the statistical deviation is significant (e.g., greater than two standard deviations from the centroid of the distribution) the data metrics subsystem identifies that metric indicator as being relevant or having some significant information indicating a person should look at it; and selects that analytic data metric or measure for use as a smart measure. If the metric indicator value deviates statistically (e.g., by two standard deviations) from the forecasted value over multiple time points, an anomaly is identified. If the metric indicator model suggests an issue or anomaly, the metric indicator may be selected for inclusion in a smart measure for the user.

In accordance with some embodiments, selected analytic data metrics or measures, such as KPIs may be provided as smart measures without further analysis. In some embodiments, data metrics subsystem can generate an explanation for the anomaly based on the model, and include that explanation with the smart measure. For example, the model of the metric indicator, the current metric indicator value, and the value of the contributing variables at that time point can be used to identify the attributes that are significant to the metric indicator at the relevant time. Once an explanation is generated, the data metrics subsystem can generate a recommendation to remedy the signal anomaly, and provide that with the smart measure.

In accordance with an embodiment, each action taken by a user in connection with a smart measure or associated dataset can be recorded by an action recorder. The recorded actions are analyzed to extract activity data and context data. Over time, such individual user episodes may reveal patterns. Data for many users may be similarly captured and used to generate personalization recommendations for the users based on the actions of other users.

In accordance with an embodiment, in providing a smart measure the system can determine, for example, for each of several analytic data metrics or measures in the system, the attributes with the highest entropy change as determined, for example, by a Shapley Additive Explanations value, or other statistical, machine learning, artificial intelligence, or other computer-automated processes.

In accordance with an embodiment, when generating the graphical representation of the smart measure, the system can select for use with smart measures those analytic data metrics or measures, KPls, or cards that have the highest (greatest) entropy change as identified above. In this way, the system can select relevant content associated with the metric indicator to be provided to the user.

The above example is provided for purposes of illustration of a particular embodiment. In accordance with various embodiments, the system can utilize additional trend determination features, such as those described for example in U.S. patent application titled “TECHNIQUES FOR DATA-DRIVEN CORRELATION OF METRICS”, application Ser. No. 16/586,347, filed on Sep. 27, 2019, and published as U.S. Patent Application Publication No. 2020/0104775 on Apr. 2, 2020.

Smart Measure User Definition

As described above, in accordance with an embodiment, a user may elect to define a smart measure themselves; alternatively the data analytic system can employ statistical, machine learning, artificial intelligence, or other computer-automated processes to learn from the community of users which aspects may be meaningful about a particular analytic metric or measure, and then update an associated metadata progressively over time, for use in generating an appropriate smart measure.

For example, in accordance with an embodiment that provides a data visualization (DV) environment, for use in creating visualizations, a user can define smart measure as explicit definition from the properties pane for the measure. Other options (e.g., chart/voice) could produce smart measures with pre-populated metadata information from a visualization or a voice query. Provided below are examples of areas that can produce the metadata required to produce a smart measure, in accordance with various embodiments:

From the properties pane: pick type; identify scope; define filters; set thresholds, trends, etc. . . .

From a chart: right click on a chart; auto populate type; auto populate scope; auto populate filter; user set's thresholds based on type.

From voice: notify if sales for a particular product in the northeast increase by 10%; send me an email when ‘quantity on hand’ for the product is less than 1000 units.

In a mobile application (app): bring back from a chart based on similar rules as desktop.

Smart Measure Notifications/Alerts

As described above, in accordance with an embodiment, once a smart measure has been defined and associated with a user, or group of users, the smart measure can be used, communicated, broadcast, or otherwise provided to the user, or to other users as contextually appropriate, for example across different/various types of computing environments, such as, for example, mobile devices, web browsers, on-premise system, or third-party applications.

In accordance with an embodiment, one of the advantages of defining a smart measure is that it can monitor a dataset for the user even when they are not looking at it, e.g., in their dashboard. The system can assess smart measures based on a set frequency and if the condition is met then produce an alert based on the user's profile settings for notification. Example user-specified notifications can include:

User Profile to configure Notification Settings: Preferred delivery method (SMS, Home Page, Email). Frequency (Daily, Weekly, Monthly). History Management.

Home Page Notifications: Ability to see pending notifications at a glance (e.g., an icon with a count). Smart measures that have been triggered could show up on the smart feed (per mobile continuity project).

Mobile Notification: SMS. Text-based alert with link back to, e.g., an Oracle Analytics Cloud home page notification area. Native mobile notification. Notification groups.

Email Notification: Rich HTML notification with image and a drill-back to home page notification area and/or project canvas that contains the smart measure that triggered the alert. Email notifications would be limited to the frequency set in each user's preferences

Smart Measures and Natural Language Processing

As described above, in accordance with an embodiment, the system can interpret input from a user, for example as text input, associated with a particular dataset or changes therein, and use natural language processing techniques in determining an appropriate smart measure.

In accordance with an embodiment, an Oracle BI Ask framework can be extended to support querying again smart measures metadata and values. This extended metadata allows for a rich set of very high business value queries such as, for example: “Show me all my measures that are trending down”; “Show me all my measures that are in critical status”; “Show me all measures that are within 80% (reach) of their goal”; “Show the top 5 measures trending in the right/wrong direction”; “Show the top 10 measures with the greatest variance from their goal”; “Show all measures that are in critical (or red) status”.

In accordance with an embodiment, the result of an, e.g., Ask query can/will return a list of smart measures as a result set. For example, the Ask home page experience can be adapted to display a result consisting of numerous smart measure performance tiles. The user should also be able to rearrange the results in several ways, for example: Sort/group by status (e.g., critical/warning/ok); Sort by distance from goal; Sort by name; Sort by variance to goal.

In accordance with an embodiment, an Yseop Natural Language Generation (NLG) engine or similar process can be used to provide support for analytic data metrics or measures that include richer sentence and observation.

For example, in accordance with an embodiment, metadata such as “Desired Direction”, “Goal/Target” and “thresholds” can help the NLG engine to make comments about the direction and variance from goal.

Smart Measure Visualizations

As described above, in accordance with an embodiment, conditional formatting can be used in presenting the smart measure as, for example, a displayed data metric or visualization. Conditional formatting enables a data analytics environment to present information in various different ways within a displayed data visualization, for example to add emphasis to a portion of the visualization to reflect relevant differences in the values of the data.

In accordance with an embodiment, a visualization author should have the ability to define and associate smart measure rules to any chart that has the measure on it. Each chart can have multiple rule ‘enabled/available’ on them; when the visualization project is then shared in presentation mode the user will have the ability to toggle the rules on the visualizations on/off however they will not be able to add rules to the visualization.

In accordance with an embodiment, smart measures interactions are the same as regular measures, however a visualization with a smart measure on it should allow the user to enrich the display with the extended attributes that come along with the smart measures. For example, such extended metadata may include: Status color (e.g., Red/Bad, Yellow/Warning, Green/Good); Trend with Sentiment (e.g., Up is Good versus Up is Bad); Actual Value & Target/Goal Value; Variance (e.g., Distance) from Goal as a Value or Percentage; or Change as a Value or Percentage from some ‘period ago’.

Example Smart Measure Metadata

As described above, in accordance with an embodiment, a smart measure can be scoped to a dataset, and associated with a metadata that indicates an understanding of the scoped data or changes thereto of interest to particular users. The data analytic system can operate in accordance with a smart measure and associated rules to monitor its associated data, and broadcast relevant information to subscribers, such as, for example, anomalies, trends, or other notable changes.

In accordance with an embodiment, a smart measure should be associated with a dataset. If the user creates a project against a dataset that has a smart measure against it then the user should have access to that smart measure in their project.

The below Example 1 illustrates a superset of the metadata elements for each smart measure type described above, in accordance with an embodiment.

| Metadata Element | Description | Explicit | Comparative | Trending | Statistical |
|---|---|---|---|---|---|
| Smart Measure | A description of this | X | X | X | X |
| name (rule name) | combination of measure and | | | | |
| | associated rules that define | | | | |
| | this smart measure. | | | | |
| Scope | A combination of dimensions | X | X | X | X |
| | and dimension members | | | | |
| | identifies the smart measure's | | | | |
| | scope. For example: | | | | |
| | “Revenue in the Northeast for | | | | |
| | smart phones this quarter” | | | | |
| | would identify a scope of the | | | | |
| | revenue smart measure. | | | | |
| Filter (scope) | The filter can further refine | X | X | X | X |
| | the scope of the smart | | | | |
| | measure. This would be the | | | | |
| | equivalent of a ‘where | | | | |
| | clause’. For example: | | | | |
| | “Revenue in the Northeast for | | | | |
| | smart phones this quarter for | | | | |
| | customers with orders over | | | | |
| | $100”. | | | | |
| Type of smart | Explicit. | X | X | X | X |
| measure | Comparative. | | | | |
| | Trending. | | | | |
| | Statistical. | | | | |
| Directionality | Up/Down/Constant is | Optional | Optional | X | X |
| | good/bad. | | | | |
| Frequency | How often the server should | X | X | X | X |
| | assess the KPI. Intially this | | | | |
| | could simple be nightly or | | | | |
| | every 24 hours. | | | | |
| Explicit Time Dim | The name of the Time | Optional | Optional | X | X |
| | dimension to key off for the | | | | |
| | calculation. If only 1 time | | | | |
| | dimension is available in the | | | | |
| | dataset then should default to | | | | |
| | that. | | | | |
| Threshold value or | | X | X | Optional | Optional |
| Goal | | | | | |
| Status or | Percentage % of Goal values | Optional | Optional | Optional | Optional |
| Conditional format | that drives the status color | | | | |
| | and/or status text. | | | | |
| | >80% of Goal = Green and | | | | |
| | is an OK Status. | | | | |
| | <80% of Goal = Yellow and | | | | |
| | Warning Status. | | | | |
| | <60% of Goal = Read and | | | | |
| | Critical Status. | | | | |

### Example 1—Smart Measure Metadata Elements

Example Smart Measure Types

In accordance with an embodiment, a smart measure can be generally constrained to a scope of data; which is useful for performance and system load consideration. There can be various different types of smart measures, such as for example:

Explicit smart measures, that compare a measure against a simple number or result of a simple expression.

Comparative smart measures, that are like explicit smart measure, but the values are the result of an expressions that involve other analytic measures.

Trending smart measures, that are focused on identifying and tracking changes when a measure is trending in the right/wrong direction.

Statistical smart measures, that are focused on identifying anomalies and when a measure has values outside its normal range.

The above are provided by way of example, and are not intended to limit embodiments to the particular examples described.

Explicit Smart Measures

In accordance with an embodiment, an explicit smart measure is useful when a user wants to see (or be alerted) when a smart measure hits a specific value that is meaningful to the business. This value can be a simple number, a percent increase/decrease or the result of a simple expression.

By way of illustration, example uses for explicit smart measures can include, e.g., a user A wants to know when he reaches his $1,000,000 quota; user A wants to know if the attrition rate in his department exceeds 6%; user A wants to know if his close rate drops by more than 10% this quarter; user A want to know when his sales of a particular product increase by 10% over today.

In accordance with an embodiment, Table 1 illustrates the metadata required to support an explicit smart measure:

TABLE 1

| | |
|---|---|
| Smart measure | A description of this combination of measure and |
| name (rule name) | associated rules that define this smart measure. |
| Scope | A combination of dimensions and dimension |
| (dimensionality) | members identifies the smart measure's scope. |
| | For example: “Revenue in the Northeast for |
| | smart phones this quarter” would identify a |
| | scope of the revenue smart measure. |
| Filter (scope) | The filter can further refine the scope of the smart |
| | measure. This would be the equivalent of a |
| | ‘where clause’. For example: “Revenue in the |
| | Northeast for smart phones this quarter for |
| | customers with orders over $100”. |
| Directionality | Up/Down/Constant is good/bad. |
| Threshold/Goal | A value or the result of a simple expression. Goal |
| | is $1M widget sales. Goal is 10% growth from now. |
| Frequency | How often the server should assess the KPI. Initially |
| | this could simple be nightly or every 24 hours. |

Comparative Smart Measures

In accordance with an embodiment, a comparative smart measure is similar to an explicit smart measure, however the value that the smart measure is using as a target is the result of an expression that is obtained from looking up another measure in the system or historical values.

By way of illustration, example uses for comparative smart measures can include, e.g., a user A wants to know when his sales reach 80% of his 2019 quota for products in the northeast. (Compare sales versus quota measure); user A wants to know when his sales have increased by 10% over last year's sales. (Compare sales this year versus sales last year); user A wants to know if his expenses are over his budget by quarter and department.

In accordance with an embodiment, Table 2 illustrates the metadata required to support comparative smart measures:

TABLE 2

| | |
|---|---|
| Smart measure | A description of this combination of measure and |
| name (rule name) | associated rules that define this smart measure. |
| Scope | A combination of dimensions and dimension |
| (dimensionality) | members identifies the smart measure's scope. |
| | For example: “Revenue in the Northeast for |
| | smart phones this quarter” would identify a |
| | scope of the revenue smart measure. |
| Filter (scope) | The filter can further refine the scope of the smart |
| | measure. This would be the equivalent of a |
| | ‘where clause’. For example: “Revenue in the |
| | Northeast for smart phones this quarter for |
| | customers with orders over $100”. |
| Directionality | Up/Down/Constant is good/bad. |
| Threshold/Goal | A value or the result of a simple expression. |
| | Expenses below Budget. Sales up 10% over |
| | last year. |
| Frequency/Action | How often the server should assess the KPI. |
| driven | Initially this could simple be nightly or every |
| | 24 hours. |

Trending Smart Measures

In accordance with an embodiment, a trending smart measure keeps track of how a measure is trending over time. The system should identify (visually and/or notify) when a measure is going through a meaningful change that will result in the trend going from good to bad.

By way of illustration, example uses for trending smart measures can include, e.g., a user A wants to know when his sales starts trending down; user A wants to know when/if his expenses start trending in the wrong direction.

In accordance with an embodiment, Table 3 illustrates the metadata required to support trending smart measures:

TABLE 3

| | |
|---|---|
| Smart measure | A description of this combination of measure and |
| name (rule name) | associated rules that define this smart measure. |
| Scope | A combination of dimensions and dimension |
| (dimensionality) | members identifies the smart measure's scope. |
| | For example: “Revenue in the Northeast for |
| | smart phones this quarter” would identify a |
| | scope of the revenue smart measure. |
| Filter (scope) | The filter can further refine the scope of the smart |
| | measure. This would be the equivalent of a |
| | ‘where clause’. For example: “Revenue in the |
| | Northeast for smart phones this quarter for |
| | customers with orders over $100” |
| Directionality | Up/Down/Constant is good/bad |
| Goal | The desired end-state of the trend. I want to |
| | identify and know when sales are going well. |
| Explicit Time/Date | The Date dimension that the system will use |
| dimension and | in the trend/forecasting algorithm. |
| Grain | |
| Frequency | How often the server should assess the KPI. |
| | Initially this could simple be nightly or every |
| | 24 hours. |

Statistical Smart Measures

In accordance with an embodiment, a statistical smart measure is like a trending smart measure; however it bases information to users as to when the smart measure is experiencing a value that is outside of the norm for that measure.

By way of illustration, example uses for statistical smart measures can include, e.g., a user A wants to know when the number of customer complaints are outside the norm; user A wants to know which measures are potentially ‘out of control’; user A wants to know which measures are likely to have a change in trend.

In accordance with an embodiment, Table 4 illustrates the metadata required to support statistical smart measure:

TABLE 4

| | |
|---|---|
| Smart measure | A description of this combination of measure and |
| name (rule name) | associated rules that define this smart measure. |
| Scope | A combination of dimensions and dimension |
| (dimensionality) | members identifies the smart measure's scope. |
| | For Example: “Revenue in the Northeast for |
| | smart phones this quarter” would identify a |
| | scope of the revenue smart measure. |
| Filter (scope) | The filter can further refine the scope of the smart |
| | measure. This would be the equivalent of a |
| | ‘where clause’. For example: “Revenue in the |
| | Northeast for smart phones this quarter for |
| | customers with orders over $100”. |
| Directionality | Up/Down/Constant is good/bad. |
| Threshold/Goal | A Statistical Smart Measure can be based on |
| | standard statistical formulas like standard |
| | Deviations (and others over time) and the |
| | user should be able to tune how far ‘outside’ |
| | the norm the measure can be, e.g., 1, 2 or 3 |
| | Standard Deviations. |
| Explicit Time/ | The Date dimension that the system will use |
| Date dimension | in the trend/forecasting algorithm. |
| Frequency | How often the server should assess the KPI. |
| | Initially this could simple be nightly or every |
| | 24 hours or simply when data is refreshed for |
| | XSA sources. |

Smart Measure Process Control Rules

As described above, in accordance with an embodiment, a system can operate in accordance with a smart measure and associated rules to monitor its associated data, and broadcast relevant information to subscribers, such as, for example, anomalies, trends, or other notable changes.

FIG. 12 illustrates various examples of rules that can be used with a system in generating and using dynamically-generated analytic data metrics or smart measures, in accordance with an embodiment.

As illustrated in FIG. 12, in accordance with an embodiment, example rules can include, for example:

Rule #1: Determination, within the data scoped to a particular smart measure, a single point beyond either control limit; an example use of this smart measure and associated rule includes the ability to detect very large/sudden shifts.

Rule #2: Determination, within the data scoped to a particular smart measure, nine (9) consecutive points on the same side of the centerline; an example use of this smart measure and associated rule includes the ability to detect small shifts or trends.

Rule #3: Determination, within the data scoped to a particular smart measure, six (6) consecutive points steadily increasing or decreasing; an example use of this smart measure and associated rule includes the ability to detect strong trends.

Rule #4: Determination, within the data scoped to a particular smart measure, fourteen (14, or more) consecutive points are alternating up and down. an example use of this smart measure and associated rule includes the ability to detect systematic effects, such as alternating machines, operators, suppliers.

Rule #5: Determination, within the data scoped to a particular smart measure, two (2) out of three (3) consecutive points at least 2 standard deviations beyond the centerline, on the same side; an example use of this smart measure and associated rule includes the ability to detect large changes.

Rule #6: Determination, within the data scoped to a particular smart measure, four (4) out of five (5) consecutive points on the chart are more than 1 standard deviation from the centerline; an example use of this smart measure and associated rule includes the ability to detect moderate-sized changes.

Rule #7: Determination, within the data scoped to a particular smart measure, fifteen (15, or more) consecutive points are within 1 standard deviation of the centerline; an example use of this smart measure and associated rule includes the ability to detect a decrease in process variation.

Rule #8: Determination, within the data scoped to a particular smart measure, eight (8, or more) consecutive points are on both sides of the centerline, but none are within 1 standard deviation; an example use of this smart measure and associated rule includes the ability to detect an increase in process variation.

The example rules shown and described in FIG. 17 are provided for purposes of illustrating an example of various types of rules that can be used to support the operation of smart measures; in accordance with various embodiments different/other types of rules can be applied to the data, to support various use cases.

Example Visualization and Use of Smart Measures

FIG. 13 illustrates an example use of smart measures, in accordance with an embodiment.

As illustrated in FIG. 13, in accordance with an embodiment, if the system observes that a particular user, or a community of users, regularly reviews a particular type of data, or performs particular actions in response to reviewing such data, then the system can begin to understand the user's (or the community's) interest in various data, or make inferences from their actions.

FIG. 14 further illustrates an example use of smart measures, in accordance with an embodiment.

As illustrated in FIG. 14, in accordance with an embodiment, once a smart measure has been defined and associated with a user, the smart measure can be used, communicated, broadcast, or otherwise provided to the user, or to other users as appropriate, for example as one or more visualizations.

FIG. 15 illustrates another example use of smart measures, in accordance with an embodiment.

As illustrated in FIG. 15, in accordance with an embodiment, as described above, the system can observe that a particular user, or a community of users, regularly reviews or generally performs actions associated with a particular type of data, and generate a smart measure.

FIG. 16 further illustrates another example use of smart measures, in accordance with an embodiment.

As illustrated in FIG. 16, in accordance with an embodiment, as described above, the smart measure can then be used, communicated, broadcast, or otherwise provided to the user, or to other users as appropriate, for example as one or more visualizations.

Example Use of Smart Measures with Application and Data Warehouse Environments

In accordance with an embodiment, smart measures can be developed for use with analytic applications environments, cloud computing, or other types of data analytics environments; for use with various types of data warehouse environments or components, such as, for example, an Oracle Autonomous Data Warehouse (ADVV), Oracle Autonomous Data Warehouse Cloud (ADWC); and vertical and/or horizontal business applications.

In accordance with an embodiment, examples of horizontal business applications can include ERP, HCM, CX, SCM, and EPM, as described above, and provide a broad scope of functionality across various enterprise organizations. Vertical business applications are generally narrower in scope that horizontal business applications, but provide access to data that is further up or down a chain of data within a defined scope or industry. Examples of vertical business applications can include medical software, or banking software, for use within a particular organization.

By way of example, FIG. 17 illustrates an example use of smart measures with a data analytics environment, in accordance with an embodiment.

The example shown and described in FIG. 17 is provided for purposes of illustrating an example of one type of analytic applications or data analytics environment. In accordance with an embodiment, the components and processes illustrated in FIG. 17, and as further described herein with regard to various other embodiments, can be provided as software or program code executable by a computer system or other type of processing device. For example, the components and processes described herein can be provided by a cloud computing system, or other suitably-programmed computer system.

As illustrated in FIG. 17, in accordance with an embodiment, an analytics environment 300 can be provided by, or otherwise operate at, a computer system having a computer hardware (e.g., processor, memory) 301, and including one or more software components operating as a control plane 302, and a data plane 304, and providing access to a data warehouse instance 360 and database 361.

In accordance with an embodiment, the control plane operates to provide control for cloud or other software products offered within the context of a SaaS or cloud environment, such as, for example, an Oracle Analytics Cloud environment. For example, in accordance with an embodiment, the control plane can include a console interface 310 that enables access by a customer (tenant) and/or a cloud environment having a provisioning component 311.

In accordance with an embodiment, the console interface can enable access by a customer (tenant) operating a graphical user interface (GUI) and/or a command-line interface (CLI) or other interface; and/or can include interfaces for use by providers of the SaaS or cloud environment and its customers (tenants).

In accordance with an embodiment, the provisioning component can be used to update or edit a data warehouse instance, and/or an ETL process that operates at the data plane, for example, by altering or updating a requested frequency of ETL process runs, for a particular customer (tenant).

In accordance with an embodiment, the data plane can include a data pipeline or process layer 320 and a data transformation layer 334, that together process operational or transactional data from an organization's enterprise software application or data environment, such as, for example, business productivity software applications provisioned in a customer's (tenant's) SaaS environment.

In accordance with an embodiment, the data transformation layer can include a data model, such as, for example, a knowledge model (KM), or other type of data model, that the system uses to transform data into a model format understood by the analytics environment.

In accordance with an embodiment, a data pipeline or process can be scheduled to execute at intervals (e.g., hourly/daily/weekly) to extract 308 transactional data from an enterprise software application or data environment, such as, for example, business productivity software applications and corresponding transactional databases 306.

In accordance with an embodiment, after transformation of the extracted data, the data pipeline or process can execute a warehouse load procedure 350, to load the transformed data into the data warehouse instance.

In accordance with an embodiment, the data warehouse can include a default analytic applications schema (referred to herein in accordance with some embodiments as an analytic warehouse schema) and, for each customer (tenant) of the system, a customer schema. Different customers of a data analytics environment may have different requirements with regard to how their data is classified, aggregated, or transformed, for purposes of providing data analytics or business intelligence data, or developing software analytic applications.

In accordance with an embodiment, to support different customer requirements as to how their data is classified, aggregated, or transformed, a semantic layer 380 can include data defining a semantic model of a customer's data; which is useful in assisting users in understanding and accessing that data using commonly-understood business terms; and provide custom content to a presentation layer 390.

In accordance with an embodiment, the presentation layer can enable access to the data content using, for example, a software analytic application, user interface, dashboard, key performance indicators (KPI's), visualizations; or other type of report or interface as may be provided by products such as, for example, Oracle Analytics Cloud.

In accordance with an embodiment, a user/developer can interact with a client computer device that includes a computer hardware (e.g., processor, storage, memory), user interface, and software application. A query engine (e.g., OBIS) operates to serve analytical queries within, e.g., an Oracle Analytics Cloud environment, pushes down operations to supported databases, and translates business user queries into appropriate database-specific query languages.

FIG. 18 illustrates a process or method for providing dynamically-generated analytic data metrics or measures, for use with a data analytics environment, in accordance with an embodiment.

As illustrated in FIG. 18, in accordance with an embodiment, at step 402, the system provides access by a community of users to an analytic applications environment, cloud computing, or other type of data analytics environment.

At step 404, the system generates smart measures that leverage, e.g., machine learning or artificial intelligence (ML/AI) processes to discover and define key performance indicators (KPIs) based on an understanding of the data and/or information received from the community of users.

At step 406, once defined, a smart measure continues to monitor its associated data, and broadcasts relevant information to listeners subscribed to that data, such as, for example, detected anomalies or trends within the data.

In accordance with various embodiments, the teachings herein may be conveniently implemented using one or more conventional general purpose or specialized computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, or other electromechanical data storage devices, floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

For example, although several of the examples provided herein illustrate operation with an enterprise software application or data analytics environment such as, for example, an Oracle Analytics Cloud environment; in accordance with various embodiments, the systems and methods described herein can be used with other types of enterprise software application or data environments, cloud environments, cloud services, cloud computing, or other computing environments.

Additionally, although several of the examples provided herein illustrate environments such as, for example, Oracle BI Server, Oracle BI Ask, and Oracle Day-by-Day, other social/shared information search and retrieval environments can be used to receive information from a community of users, associated with accessing and using data, which the system can then employ in understanding the user's interests, and generating appropriate smart measures, or associating particular smart measures with actions that are likely to be of interest to the user; in accordance with various embodiments, smart measures can also be generated by and/or used with other types of social/shared information search and retrieval environments, or other types of analytic applications environments, cloud computing, or data analytics environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for providing dynamically-generated analytic data metrics or measures, for use with a data analytics environment, comprising:
a computer including one or more processors, that provides access to a data analytics environment including a data analytic system;
wherein the data analytic system generates analytic data metrics operating as smart measures, each of which dynamically-generated analytic data metric is associated with a metadata that indicates a scope of data of interest to a user or group of users; and
wherein the system operates in accordance with a defined smart measure to monitor its associated data and broadcast analytic information describing the associated data to subscribed listeners, including one or more detected anomalies, trends, or changes within the data.

2. The system of claim 1, wherein smart measures are automatically discovered and updated by the system based on an understanding of the data and/or information received from a community of users.

3. The system of claim 2, wherein the data analytic system records an indication of updated knowledge/understanding as an updated metadata/rules associated with a smart measure.

4. The system of claim 3, wherein once a smart measure has been defined and associated with a user, or group of users, the smart measure is communicated, broadcast, or otherwise provided to the user, or to other users as contextually appropriate across different/various types of computing environments, including one or more mobile devices, web browsers, on-premise system, or third-party applications.

5. The system of claim 1, wherein the system applies conditional formatting to present the analytic data metric provided by a smart measure in a readily-identifiable format.

6. A method for providing dynamically-generated analytic data metrics or measures, for use with a data analytics environment, comprising:
providing, by a computer including one or more processors, that provides access to a data analytics environment including a data analytic system;
wherein the data analytic system generates analytic data metrics operating as smart measures, each of which dynamically-generated analytic data metric is associated with a metadata that indicates a scope of data of interest to a user or group of users; and
wherein the system operates in accordance with a defined smart measure to monitor its associated data and broadcast analytic information describing the associated data to subscribed listeners, including one or more detected anomalies, trends, or changes within the data.

7. The method of claim 6, wherein smart measures are automatically discovered and updated by the system based on an understanding of the data and/or information received from a community of users.

8. The method of claim 7, wherein the data analytic system records an indication of updated knowledge/understanding as an updated metadata/rules associated with a smart measure.

9. The method of claim 8, wherein once a smart measure has been defined and associated with a user, or group of users, the smart measure is communicated, broadcast, or otherwise provided to the user, or to other users as contextually appropriate across different/various types of computing environments, including one or more mobile devices, web browsers, on-premise system, or third-party applications.

10. The method of claim 6, wherein the system applies conditional formatting to present the analytic data metric provided by a smart measure in a readily-identifiable format.

11. A non-transitory computer readable storage medium having instructions thereon, which when read and executed by a computer including one or more processors cause the computer to perform a method comprising:
providing, by a computer including one or more processors, that provides access to a data analytics environment including a data analytic system;
wherein the data analytic system generates analytic data metrics operating as smart measures, each of which dynamically-generated analytic data metric is associated with a metadata that indicates a scope of data of interest to a user or group of users; and
wherein the system operates in accordance with a defined smart measure to monitor its associated data and broadcast analytic information describing the associated data to subscribed listeners, including one or more detected anomalies, trends, or changes within the data.

12. The non-transitory computer readable storage medium of claim 11, wherein smart measures are automatically discovered and updated by the system based on an understanding of the data and/or information received from a community of users.

13. The non-transitory computer readable storage medium of claim 12, wherein the data analytic system records an indication of updated knowledge/understanding as an updated metadata/rules associated with a smart measure.

14. The non-transitory computer readable storage medium of claim 13, wherein once a smart measure has been defined and associated with a user, or group of users, the smart measure is communicated, broadcast, or otherwise provided to the user, or to other users as contextually appropriate across different/various types of computing environments, including one or more mobile devices, web browsers, on-premise system, or third-party applications.

15. The non-transitory computer readable storage medium of claim 11, wherein the system applies conditional formatting to present the analytic data metric provided by a smart measure in a readily-identifiable format.
